(19) United States
(12) Patent Application Publication
(10) Pub. No.: US 2020/0276894 A1
(43) Pub. Date: Sep. 3, 2020

(54) CUSTOM GRAPHIC SOFT TOP AND PROCESS

(71) Applicant: Bestop, Inc., Louisville, CO (US)

(72) Inventor: Eric D. Getzschman, New Baltimore, MI (US)

(73) Assignee: BESTOP INC., Louisville, CO (US)

(21) Appl. No.: 16/805,111

(22) Filed: Feb. 28, 2020

Related U.S. Application Data
(60) Provisional application No. 62/812,544, filed on Mar. 1, 2019.

(51) Int. Cl. B60J 7/12; B62D 65/02

(52) U.S. Cl. CPC B60J 7/1291; B62D 65/02

(57) ABSTRACT

A process for manufacture of a custom pattern soft top for a vehicle. First, a printable marker sheet which matches the size for forming the layout of a plurality of sown together parts of a soft top for a vehicle is provided. Thereafter the design is printed onto the marker sheet in orientations on each individual part of said plurality of sewn together part such that the design on each part is configured and laid out to match the orientation of the pattern for that part on the vehicle. The parts of the top with the designs are then cut and assembled a final top which results in the design being displayed on all parts in proper orientation when installed on a vehicle.

### FIELD OF THE INVENTION

The present invention relates to a method and top made with a custom design.

### BACKGROUND OF THE INVENTION

The art of building soft tops is complex. A 3-dimensional flexible top must be sewn together out of a flat fabric in order to make a three dimensional top shell that fits over a framework and attached to the vehicle. Bestop, Inc. has long been a quality provider of unique and advanced tops in this area particularly for Jeep and other SUV, UTV and ATV vehicles.

Much innovation has been made in the area of hardtops. Various colors of materials for hardtops have been available. Although, the number of colors is limited. This is due primarily to manufacturing limitations in that Minimum Order quantities of a specific top fabric tend to provide the impetus for using a certain color. This is essential in order to make producing a top in a cost effective manner.

Typically, the “pieces” of a particular top design are laid out in the most efficient way possible on any particular solid fabric color (typically black) and then stacks of these sheets are placed on a cutting machine and the patterns are cut as one.

Because of this there has been no commercial way to make any sort of custom color or particularly custom graphics on any tops. While there may be embroiderers or one off type tops which have graphics on them. These types of tops are highly custom and extremely expensive and cost prohibitive. Therefore, there remains a need in the art to provide a cost effective manufacturing process for creating a top with custom graphics. It is also desirable to provide custom graphics that can represent customer favored designs and logos representing various geographic and political entities. It is also desirable to provide custom graphic designs or logos representing various youth league, high school, college or professional sports teams. It is also desirable to provide custom graphics based on customer supplied photograph or other graphics.

### SUMMARY OF THE INVENTION

To make manifest the above delineated and other positive desires, a revelation of the present invention is brought forth. In a preferred embodiment the present invention provides the freedom of a process for manufacture of a custom pattern soft top for a vehicle and an article of manufacture made thereof. First, a printable marker sheet which matches the size for forming the layout of a plurality of sown together parts of a soft top for a vehicle is provided. Thereafter the design is printed onto the marker sheet in orientations on each individual part of said plurality of sewn together part such that the design on each part is configured and laid out to match the orientation of the pattern for that part on the vehicle. The parts of the top with the designs are then cut and assembled a final top which results in the design being displayed on all parts in proper orientation when installed on a vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view showing a marker sheet with a pattern printed for final design implementation of a vehicle;

FIG. 2 is a cross section of a printed fabric laminate in accordance with the teachings of the present invention;

FIG. 3 is a cross section of a printed fabric laminate showing an alternate embodiment of the present invention;

FIG. 4 is a sectional view showing the pattern printed on the outermost surface either with a UV protected ink or coated with a UV protection coating; and,

FIG. 5 is a perspective view showing a desired pattern to be achieved on a vehicle soft top.

### DETAILED DESCRIPTION OF THE PREFERRED EMBODIMENTS

The following description of the preferred embodiment(s) is merely exemplary in nature and is in no way intended to limit the invention, its application, or uses.

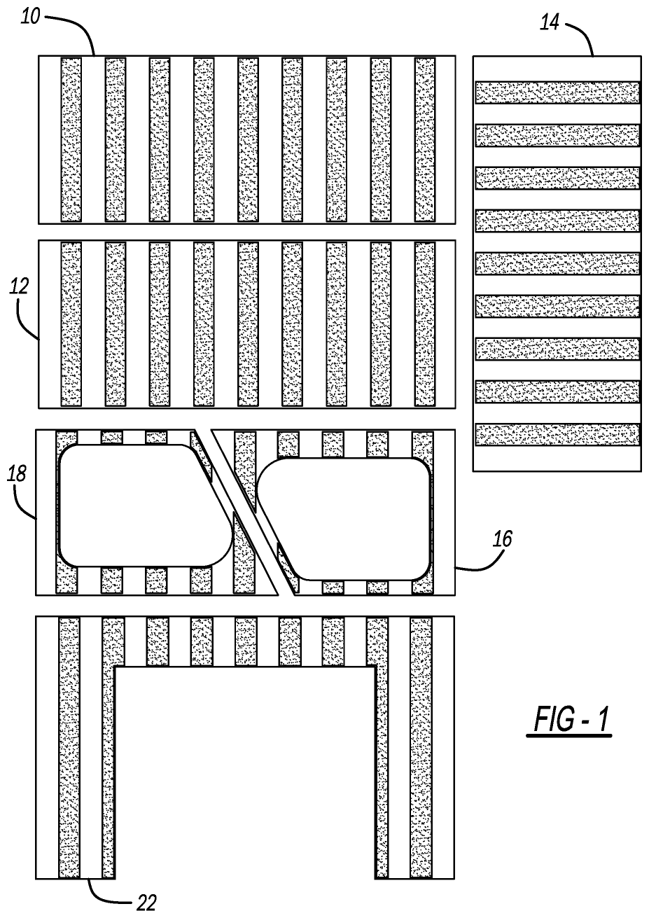

In accordance with the present invention there is provided a process for manufacture of a custom pattern soft top for a vehicle. First the vehicle make, year and model are specified. Secondly, a printable marker sheet which matches the size for forming the layout of a plurality of sewn together parts of a soft top for a vehicle is provided. The design is them specified. The design can be taken from an electronic library that may include multiple geographic political or sports emblems, designs or logos. If a logo is specified, an appropriate licensing fee can be noted, especially if the design is trademarked by an owning entity. Alternatively, the design can be scanned from a customer supplied graphics. Or the design can be a combination of a design taken from a library (in most instances an electronic library) and combined with a customer supplied scanned graphic or background. Thereafter the design is printed onto the marker sheet in a properly determined orientation on each individual part of said plurality of sewn together part such that the design on each part is configured and laid out to match the orientation of the pattern for that part on the vehicle. The process further includes for instance an American flag most parties would prefer that the blue stars portion of the flag with the blue background be oriented toward the front of the vehicle rather than toward a rear end. Therefore the stars portion on the left D Piller will be oriented towards the front end on both D. Pillers. If the customer should specify the logo of a collegiate university sports team such as Colorado State University (CSU). The letter CSU needs to be in the proper, orientation when displayed on the D Piller side window panel. If the customer specified the famous University of Colorado Buffalo logo, the head of the Buffalo it should be oriented to the front of the vehicle for both D. Pillers. The proper orientation of the graphics can be determined manually or an AI (Artificial Intelligence) program. Referring to FIG. 1, for illustrative purposes a stripped design is printed out onto a marker sheet as shown. Thus, parts for the top include a front top section 10, a middle top section 12 and a back top section 14. Side window panels 16 and 18 are also printed along with the rear u shaped fabric member which includes side members 20 and 22.

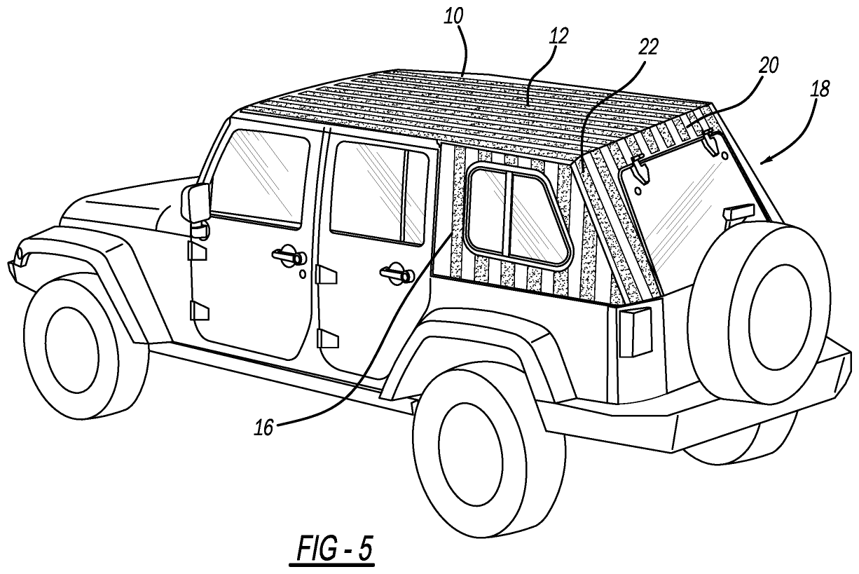

The parts of the top with the designs are then cut and assembled into a final top as shown in FIG. 5 which results in the design being displayed on all parts in proper orientation when installed on a vehicle. While a striped design is shown it will be readily appreciated that any custom design can be designed a printed on the marker sheet regardless of the final orientation of the individual parts of the top in order to allow for a custom final proper orientation of a complete design.

Using a computer and a large scale graphics printer, a top template called a “marker” sheet is printed with a custom design on a vinyl sheet. This allows the pattern of the design to be printed such that it is aligned in the final 3D installation orientation rather than for instance cutting the “to be sewed” parts from a fabric of a particular design. This is because the parts are typically oriented on a sheet of fabric in the pattern of conservation of material for cutting the shapes with no consideration of final matching of design features (whether it be camouflage flowers large graphics or essentially other Wall paper type patterns. Thus, in the present process if the pattern of say the stripes of an American flag are to follow say vertically down the back D pillar area the stripes need to be printed in an entirely different direction than the “main” part of the top which could not be facilitated from a single pattern sheet.

Printing can be accommodated on such a large scale typically an 8 foot wide large format printer such as an HP model 26500 printing on a vinyl, PVC. (polyvinyl chloride) or other film substrate can be utilized. Other methods of printing such as Gravier printing could be used.

As shown in FIG. 5, after the sheet is printed with the pattern on each part of the sewn together top printed in its proper final assembled configuration. The sheet is laminated into a suitable rugged soft top substrate material and thereafter cut and assembled into the final graphically correct top.

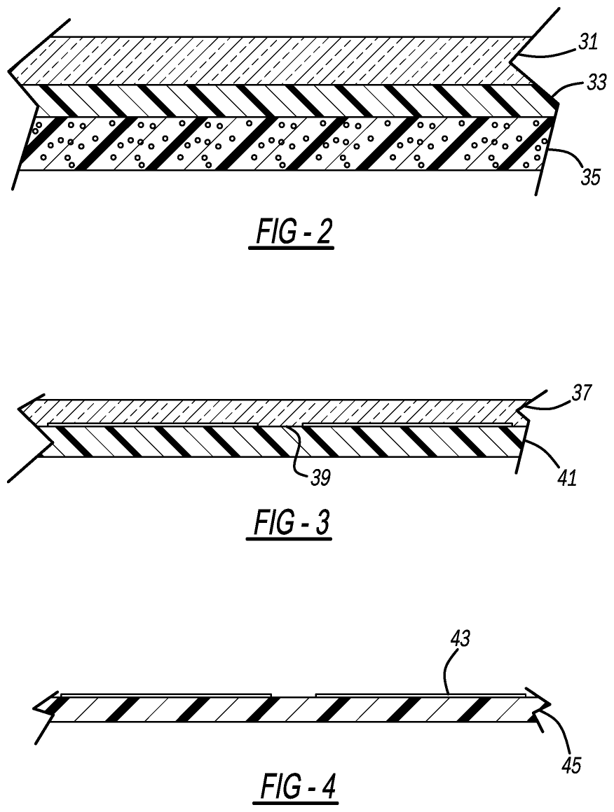

As shown in FIG. 2, in a preferred embodiment the vinyl graphic film has a clear or tinted or contrasting PVC, UV (ultra violet) and scratch resistant layer 31 laminated, sprayed or otherwise applied over the design (marker sheet) 37 and a strong textile such as a Polyester or polycotton or cotton fabric is laminated as a substrate 35. Thus a 3 layer laminate is provided in this embodiment.

In an alternate embodiment a two layer system is show in FIG. 3. In this embodiment a UV resistant clear or tinted or translucent sheet 37 has the design 39 printed on the back of it and it is then laminated onto the fabric substrate 41. Alternatively, as shown in FIG. 4, the design 43 can be printed directly on the substrate 45 with a UV resistant ink and or thereafter covered by a UV resistant coating (not shown). The design can also utilize luminescent ink or provide a desired design that is a combination of a painted color, a color of a substrate and/or the tint of a translucent or clear coating. The design can also be configured to change appearance due to a blue light provided by interior lighting (normal lighting or ultraviolet lighting supplied by interior lighting of the vehicle especially interacting with luminescent paint designs).

The top coating if utilized can be sprayed extruded or laminated.

In operation the process of the present invention allows a one off top with any unique design desired by the purchaser, to be custom made on an economical and rapid basis. Additionally, the process would be useful for small runs of custom designed tops for limited run vehicles or the like. The sheet could be formed and then placed on a cutting apparatus with a number of standard black or other color sheets of soft top material and cut with these tops. When assembled the final design is perfectly implemented on the top with the pattern aligned as designed. Patterns are designed on computer graphics programs, photographs, or other similar manners and then a computer is used to lay them in the proper orientation on the marker sheet for cutting.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A process for manufacture of a custom pattern soft top for a vehicle comprising;
providing a printable marker sheet which matches the size for forming the layout of a plurality of sown together parts of a soft top for a vehicle;
printing the design onto the marker sheet in orientations on each individual part of said plurality of sewn together part such that the design on each part is configured and laid out to match the orientation of the pattern for that part on the vehicle;
cutting the parts of the top with the designs and assembling a final top to a vehicle.

2. The process of claim 1 wherein cutting the parts further comprises assembling the printable marker sheet onto a fabric material substrate for the top and cutting the top pieces from the resulting assembly.

3. The process of claim 2 wherein the printable marker sheet and the fabric substrate are layered on each other for providing a two layered assembly.

4. The process of claim 3 wherein the printable marker sheet is coated by or comprises a UV resistant film.

5. The process of claim 1 wherein the pattern is printed on a printable marker sheet formed by a fabric substrate.

6. The process of claim 4 wherein the design color is a combination of a tinted coating or film and a substrate.

7. The process of claim 1 wherein the design is luminescence.

8. The process of claim 1 further including specifying the vehicle the top is provided for to determine the size the marker sheet that is provided.

9. The process of claim 1 further including specifying the design from a library of graphic designs.

10. The process of claim 1 further including scanning a customer provided graphic for specifying the design.

11. The process of claim 1 further including manually determining the design printing orientations on the individual parts.

12. The process of claim 1 further comprising utilizing AI for determining the design printing orientations on the individual parts.

13. A process for manufacture of a custom pattern soft top for a vehicle comprising;
specifying the vehicle that the top is provided for;
providing a printable marker sheet which matches the specified vehicle and size for forming the layout of a plurality of sown together parts of the soft top for the specified vehicle;
specifying a design for the soft top from a library or from a customer supplied graphic.
printing the design onto the marker sheet in manually or AI determined orientations on each individual part of said plurality of sewn together part such that the design on each part is configured and laid out to match the orientation of the pattern for that part on the vehicle;
cutting the parts of the top with the designs and assembling a final top to a vehicle.

14. A vehicle top provided by the process of claim 1.

15. A vehicle top provided by the process of claim 13.
